(19) United States
(12) Patent Application Publication
(10) Pub. No.: US 2024/0288939 A1
(43) Pub. Date: Aug. 29, 2024

(54) INFORMATION PROCESSING APPARATUS AND INFORMATION PROCESSING METHOD

(71) Applicants: SONY GROUP CORPORATION, Tokyo (JP); Sony Interactive Entertainment Inc., Tokyo (JP)

(72) Inventors: Yusuke KAWABE, Tokyo (JP); Noriyoshi TAKAHOTA, Kanagawa (JP); Daichi ONO, Tokyo (JP)

(73) Assignees: SONY GROUP CORPORATION, Tokyo (JP); Sony Interactive Entertainment Inc., Tokyo (JP)

(21) Appl. No.: 18/694,434

(22) PCT Filed: Oct. 4, 2022
(86) PCT No.: PCT/JP2022/037061

§ 371 Date: Mar. 22, 2024

(30) Foreign Application Priority Data
Oct. 13, 2021 (JP) 2021-167989

(51) Int. Cl. G06F 3/01; B25J 9/16; G06F 3/16

(52) U.S. Cl. CPC G06F 3/014; B25J 9/1612; G06F 3/016; G06F 3/16

(57) ABSTRACT

An information processing apparatus including: an image control unit that controls a communication image including an image of a performer or an avatar and displayed on a display unit installed in a separated space and having a vertical direction as a longitudinal direction; and a hand control unit that controls movement of a robot hand that provides an experience by a tactile sense to an experiencing person who has visually recognized the image.

### FIELD

The present disclosure relates to an information processing apparatus and an information processing method.

### BACKGROUND

A telepresence system that transmits video and voice between spaces separated from each other to make a user feel as if the spaces are connected has become widespread.

For example, Patent Literature 1 below discloses a technique for efficiently detecting a face image of a person from an image captured by a camera in a telepresence system or the like.

### CITATION LIST

### Patent Literature

Patent Literature 1: JP 2014-103479 A

### SUMMARY

### Technical Problem

In recent years, in a telepresence system, it is possible to express a person appearing in a video as if the person is in that place more vividly by improving quality of the video and voice.

Therefore, it has been required to provide a new experience with a higher realistic feeling by the telepresence system.

### Solution to Problem

According to the present disclosure, an information processing apparatus is provided that includes: an image control unit that controls a communication image including an image of a performer or an avatar and displayed on a display unit installed in a separated space and having a vertical direction as a longitudinal direction; and a hand control unit that controls movement of a robot hand that provides an experience by a tactile sense to an experiencing person who has visually recognized the image.

Moreover, according to the present disclosure, an information processing method is provided that includes: by means of a computer, controlling a communication image displayed on a display unit installed at a separated place and having a vertical direction as a longitudinal direction; and controlling movement of a robot hand that provides an experience by a tactile sense to an experiencing person who has visually recognized the image.

### BRIEF DESCRIPTION OF DRAWINGS

FIG. 1 is an explanatory view for explaining an overview of a telepresence system including an information processing apparatus according to an embodiment of the present disclosure.

FIG. 2 is a block diagram for explaining a functional configuration of the telepresence system including the information processing apparatus according to the embodiment.

FIG. 3 is a flowchart for explaining an example of an operation of the telepresence system including the information processing apparatus according to the embodiment.

FIG. 4 is an explanatory view illustrating a configuration for controlling localization of voice output from an acoustic unit of an experience providing apparatus.

FIG. 5 is an explanatory view illustrating a configuration for controlling localization of the voice output from the acoustic unit of the experience providing apparatus.

FIG. 6 is an explanatory view illustrating a positional relationship between a capture unit and a display unit of the information processing apparatus.

FIG. 7 is an explanatory view illustrating an example in which the capture unit and the display unit are arranged on the same axis using a half mirror.

FIG. 8 is an explanatory view illustrating a communication image to which an effect image corresponding to pressure applied to a hand unit is added.

FIG. 9 is an explanatory view illustrating the display unit in which information regarding the pressure applied to the hand unit is presented.

FIG. 10 is an explanatory view illustrating an aspect of the experience providing apparatus in a case where input has been performed to an input device.

FIG. 11 is an explanatory view illustrating the experience providing apparatus provided with a first hand unit and a second hand unit corresponding to both hands.

FIG. 12 is an explanatory view illustrating the experience providing apparatus provided with a first hand unit and a second hand unit corresponding to both arms.

FIG. 13 is an explanatory view for explaining a method of avoiding duplication of the hand unit and a hand of a performer or an avatar.

FIG. 14 is an explanatory view for explaining a method of avoiding duplication of the hand unit and the hand of the performer or the avatar.

FIG. 15 is an explanatory view for explaining an experience in which an object displayed on the display unit is delivered to an experiencing person as a real object.

FIG. 16 is an explanatory view illustrating a robot hand structure capable of following forward, backward, leftward, and rightward movement from the experiencing person.

FIG. 17 is an explanatory view for explaining a configuration of an end portion that enables movement close to a human hand.

FIG. 18 is an explanatory view for explaining a configuration of a finger portion that enables movement close to a human finger.

FIG. 19 is an explanatory view illustrating an example of an image for presenting the performer with a positional relationship between a hand of the experiencing person and the hand unit.

FIG. 20 is an explanatory view for explaining a function of a performer side hand unit.

FIG. 21 is a block diagram illustrating a hardware configuration example of the information processing apparatus according to the embodiment.

### DESCRIPTION OF EMBODIMENTS

Hereinafter, a preferred embodiment of the present disclosure will be described in detail with reference to the accompanying drawings. Note that, in the present specification and the drawings, components having substantially the same functional configuration are denoted by the same reference numeral, and redundant description is omitted.

Note that the description will be given in the following order.
1. Overview
2. Configuration Example
3. Control Example
4. Detailed Configurations
5. Hardware Configuration Example

### 1. Overview

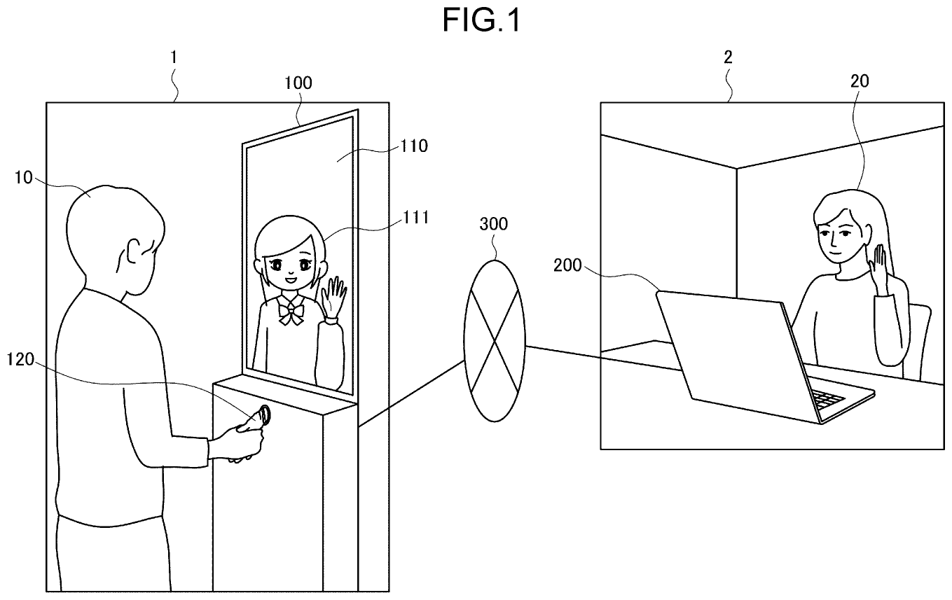

First, an overview of a telepresence system including an information processing apparatus according to an embodiment of the present disclosure will be described with reference to FIG. 1. FIG. 1 is an explanatory view for explaining an overview of a telepresence system including an information processing apparatus 200 according to the present embodiment.

As illustrated in FIG. 1, the telepresence system according to the present embodiment includes an experience providing apparatus 100 provided in a first space 1 and the information processing apparatus 200 provided in a second space 2 separated from the first space 1.

The experience providing apparatus 100 and the information processing apparatus 200 are connected to each other via a communication network 300 such as the Internet, a wide area network (WAN), or a local area network (LAN), and are provided so as to be able to transmit and receive various data such as image data and voice data. However, it goes without saying that the experience providing apparatus 100 and the information processing apparatus 200 may be directly connected on a one-to-one basis without the communication network 300.

The experience providing apparatus 100 includes, for example, a display unit 110 and a hand unit 120, and provides a communication experience for an experiencing person 10 present in the first space 1. For example, the display unit 110 is a vertical display device having a size in which a full-size upper body of a human is reflected. The hand unit 120 is a robot hand device imitating a human hand provided below the display unit 110.

Specifically, the experience providing apparatus 100 provides visual and auditory experiences such as conversation via a communication image 111 displayed on the display unit 110, and provides the experiencing person 10 with an experience by a tactile sense such as a handshake via the hand unit 120. The communication image 111 includes, for example, a captured image of a performer 20 operating the information processing apparatus 200 or an image of an avatar tracing expression or gesture of the performer 20.

According to this, the experience providing apparatus 100 displays a substantially full-size image of the performer 20 or the avatar on the display unit 110 by the communication image 111, so that it is possible to provide an experience as if the experiencing person 10 actually has conversation with the performer 20 or the avatar. Furthermore, the experience providing apparatus 100 can provide an experience as if the experiencing person 10 actually shakes hands with the performer 20 or the avatar of the performer 20 by causing the experiencing person 10 to touch the hand unit 120 whose movement is controlled in conjunction with gesture or conversation of the image of the performer 20 or the avatar.

The information processing apparatus 200 controls a communication experience provided from the experience providing apparatus 100 to the experiencing person 10. Specifically, the information processing apparatus 200 controls the communication image 111 displayed on the display unit 110 of the experience providing apparatus 100 and controls the movement of the hand unit 120. For example, the information processing apparatus 200 may generate the captured image of the performer 20 or the avatar image tracing the performer 20 on the basis of a captured image of the performer 20 or a sensing result. Furthermore, the information processing apparatus 200 may control the movement of the hand unit 120 on the basis of movement of a hand of the performer 20 having recognized the image.

Therefore, the telepresence system according to the present embodiment can make the experiencing person 10 present in the first space 1 experience conversation, a handshake, and the like with the performer 20 present in the second space 2 in a pseudo manner via the communication image 111 and the hand unit 120. Accordingly, the telepresence system can provide the experiencing person 10 with a more realistic communication experience with the performer 20 or the avatar.

### 2. Configuration Example

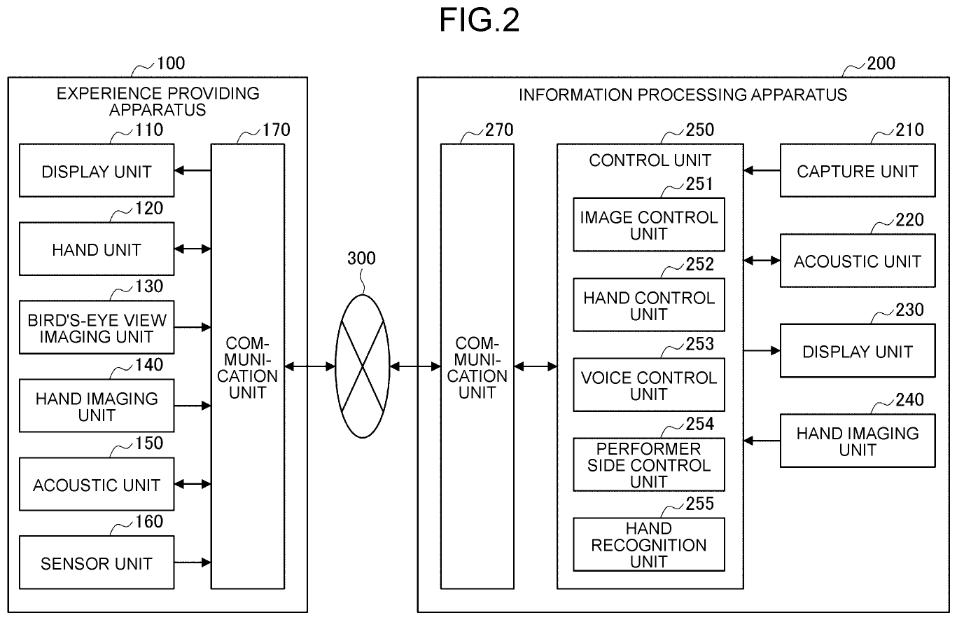

Next, a configuration example of the telepresence system including the information processing apparatus 200 according to the present embodiment will be described with reference to FIG. 2. FIG. 2 is a block diagram for explaining a functional configuration of the telepresence system including the information processing apparatus 200 according to the present embodiment.

As illustrated in FIG. 2, the telepresence system according to the present embodiment includes the experience providing apparatus 100 and the information processing apparatus 200 connected to each other via the communication network 300.

### (Experience Providing Apparatus 100)

The experience providing apparatus 100 includes the display unit 110, the hand unit 120, a bird's-eye view imaging unit 130, a hand imaging unit 140, an acoustic unit 150, a sensor unit 160, and a communication unit 170.

The display unit 110 includes, for example, a vertical display device having a size in which a full-size upper body of a human is reflected and having a vertical direction as a longitudinal direction. The display unit 110 displays the communication image 111 including a captured image of the performer 20 or an avatar image of the performer 20. Accordingly, the display unit 110 can display the communication image 111 including a full-size image of the performer 20 or the avatar. Therefore, the display unit 110 can visually present a realistic experience as if the performer 20 or the avatar exists in front of eyes to the experiencing person 10.

The hand unit 120 includes a robot hand device having a structure imitating a human hand. Specifically, similarly to the human hand, the hand unit 120 includes a robot hand device that has a structure including a palm and five fingers extending from the palm and reproduces body temperature and feel. The hand unit 120 performs a closing or opening motion based on the motion of the hand of the performer 20, so that it is possible to provide the experiencing person 10 with an experience as if the experiencing person is actually in contact with the performer 20 or the avatar, such as shaking hands, in a tactile manner.

The robot hand device included in the hand unit 120 may be provided below the display unit 110.

Specifically, the robot hand device included in the hand unit 120 may be provided below the display unit 110 so as to be arranged at a position corresponding to a hand of the full-size image of the performer 20 or the avatar displayed on the display unit 110.

The bird's-eye view imaging unit 130 includes an imaging device that images a predetermined area in front of the experience providing apparatus 100 in a bird's-eye view. The bird's-eye view imaging unit 130 images expression or movement of the experiencing person 10 who stands in a predetermined area in front of the experience providing apparatus 100 and is provided with a communication experience. The captured image of the experiencing person 10 is visually presented to the performer 20 via a display unit 230 of the information processing apparatus 200, for example.

The hand imaging unit 140 includes an imaging device that images the vicinity of the hand unit 120. The hand imaging unit 140 images a contact state such as a handshake between the experiencing person 10 and the hand unit 120. The captured image of the contact between a hand of the experiencing person 10 and the hand unit 120 is visually presented to the performer 20 via the display unit 230 of the information processing apparatus 200, for example.

The acoustic unit 150 includes a speaker, and aurally presents the experiencing person 10 with voice of the performer 20 collected by an acoustic unit 220 of the information processing apparatus 200. The acoustic unit 150 may be provided, for example, at the center of a back surface of the display unit 110. According to this, the acoustic unit 150 can output the voice of the performer 20 as if the voice has been uttered from a mouth of the performer 20 or the avatar in the communication image 111 displayed on the display unit 110. Furthermore, the acoustic unit 150 includes a microphone and collects voice of the experiencing person 10. The collected voice of the experiencing person 10 is aurally presented to the performer 20 via the acoustic unit 220 of the information processing apparatus 200, for example.

The sensor unit 160 includes a pressure sensor or a force sensor provided in the hand unit 120. For example, the pressure sensor or the force sensor may be provided in an area corresponding to the palm of the hand unit 120. The sensor unit 160 detects pressure applied to the hand unit 120 from the experiencing person 10 by contact such as a handshake. The pressure detected by the sensor unit 160 is transmitted to, for example, the information processing apparatus 200, is used for controlling the communication image 111 displayed on the display unit 110, and is visually presented to the performer 20 via the display unit 230.

The communication unit 170 is a communication interface including a communication device for connecting the experience providing apparatus 100 to the communication network 300. The communication unit 170 may be, for example, a communication interface for a wired or wireless local area network (LAN), a router for optical communication, a router for an asymmetric digital subscriber line (ADSL), or a modem for various communications.

### (Information Processing Apparatus 200)

The information processing apparatus 200 includes a capture unit 210, the acoustic unit 220, the display unit 230, a hand imaging unit 240, a control unit 250, and a communication unit 270.

The capture unit 210 includes an imaging device or motion capture that acquires expression or gesture of the performer 20. For example, the capture unit 210 can acquire the expression or gesture of the performer 20 as a captured image of the performer 20 by using the imaging device. Furthermore, the capture unit 210 can acquire the expression or gesture of the performer 20 as motion data by using the motion capture. The motion data of the performer 20 is used, for example, to generate an avatar image that traces the expression or gesture of the performer 20.

The acoustic unit 220 includes a speaker, and aurally presents the performer 20 with voice of the experiencing person 10 collected by the acoustic unit 150 of the experience providing apparatus 100. Furthermore, the acoustic unit 220 includes a microphone and collects voice of the performer 20. The collected voice of the performer 20 is aurally presented to the experiencing person 10 via the acoustic unit 150 of the experience providing apparatus 100, for example.

The display unit 230 includes a general display device, and displays various images visually provided for the performer 20. Specifically, the display unit 230 may display a captured image of the experiencing person 10 captured by the bird's-eye view imaging unit 130, a captured image of contact between the hand of the experiencing person 10 and the hand unit 120 captured by the hand imaging unit 140, and a display image of the display unit 110. The performer 20 can smoothly communicate with the experiencing person 10 by visually recognizing these various images.

The hand imaging unit 240 includes an imaging device that images the hand of the performer 20. A captured image of the hand of the performer 20 is used, for example, to determine the movement of the hand of the performer 20 by image recognition.

The control unit 250 includes an image control unit 251, a hand control unit 252, a voice control unit 253, a performer side control unit 254, and a hand recognition unit 255, and controls various experiences provided from the experience providing apparatus 100 for the experiencing person 10.

The image control unit 251 controls the communication image 111 displayed on the display unit 110. Specifically, the image control unit 251 may generate the communication image 111 including the captured image of the performer 20 on the basis of the captured image of the performer 20 acquired by the capture unit 210. Furthermore, the image control unit 251 may generate the communication image 111 including the avatar image that traces the expression or gesture of the performer 20 on the basis of the motion data of the performer 20 acquired by the capture unit 210. Furthermore, the image control unit 251 may control a background image or an effect image included in the communication image 111.

The hand recognition unit 255 recognizes the movement of the hand of the performer 20. Specifically, the hand recognition unit 255 recognizes the movement of the hand of the performer 20 by performing image recognition on the captured image of the hand of the performer 20 acquired by the hand imaging unit 240.

The hand control unit 252 controls the movement of the hand unit 120. Specifically, the hand control unit 252 controls the movement of the hand unit 120 so as to perform movement similar to the movement of the hand of the performer 20 recognized by the hand recognition unit 255. Accordingly, the hand control unit 252 can cause the hand unit 120 to reproduce, in the first space 1, the movement of the hand performed by the performer 20 in the second space 2.

The voice control unit 253 controls the voice presented from the acoustic unit 150 to the experiencing person 10. Specifically, the voice control unit 253 may cause the acoustic unit 150 to output the voice of the performer 20 collected by the acoustic unit 220. Further, the voice control unit 253 may process or edit the voice of the performer 20 collected by the acoustic unit 220 by signal processing. Furthermore, the voice control unit 253 may control localization of the voice of the performer 20 output by the acoustic unit 150.

The performer side control unit 254 controls information presented to the performer 20. Specifically, the performer side control unit 254 controls voice aurally presented to the performer 20 from the acoustic unit 220 and an image visually presented to the performer 20 from the display unit 230. For example, the performer side control unit 254 may output the voice of the experiencing person 10 collected by the acoustic unit 150 from the acoustic unit 220. In addition, the performer side control unit 254 may cause the display unit 230 to display the captured image of the experiencing person 10 captured by the bird's-eye view imaging unit 130, the captured image of the contact between the hand of the experiencing person 10 and the hand unit 120 captured by the hand imaging unit 140, and the display image of the display unit 110.

The communication unit 270 is a communication interface including a communication device for connecting the information processing apparatus 200 to the communication network 300. The communication unit 270 may be, for example, a communication interface for a wired or wireless local area network (LAN), a router for optical communication, a router for an asymmetric digital subscriber line (ADSL), or a modem for various communications.

According to the above configuration, the telepresence system according to the present embodiment can provide the experiencing person 10 existing in the first space 1 with an experience accompanied by a tactile sense such as a handshake in addition to conversation with the performer 20 existing in the second space 2. Therefore, the telepresence system according to the present embodiment can provide the experiencing person 10 with a more realistic communication experience with the performer 20 or the avatar.

### 3. Control Example

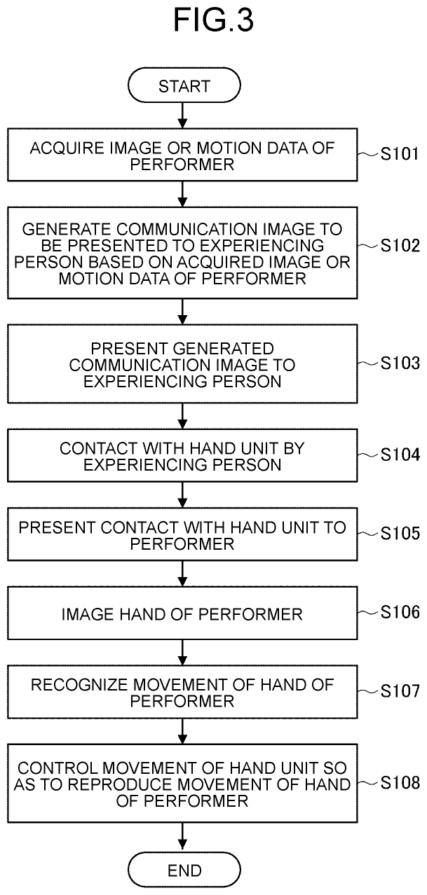

Next, an operation example of the telepresence system including the information processing apparatus 200 according to the present embodiment will be described with reference to FIG. 3. FIG. 3 is a flowchart for explaining an example of an operation of the telepresence system including the information processing apparatus 200 according to the present embodiment.

As illustrated in FIG. 3, first, the information processing apparatus 200 acquires an image or motion data of the performer 20 by using the capture unit 210 (S101). Next, the information processing apparatus 200 generates the communication image 111 to be presented to the experiencing person 10 on the basis of the acquired image or motion data of the performer 20 (S102). For example, the information processing apparatus 200 may generate the communication image 111 including the captured image of the performer 20 or the avatar image that traces the motion of the performer 20. Subsequently, the information processing apparatus 200 transmits the generated communication image 111 to the experience providing apparatus 100. As a result, the experience providing apparatus 100 can present the communication image 111 to the experiencing person 10 by using the display unit 110 (S103).

Here, it is assumed that the experiencing person 10 has made contact with the hand unit 120 of the experience providing apparatus 100 by shaking hands or the like (S104). In such a case, the contact of the experiencing person 10 with the hand unit 120 is presented to the performer 20 by a captured image of the hand imaging unit 140 (S105). The performer 20 moves the hand in accordance with the contact of the experiencing person 10 with the hand unit 120, and the hand that has been moved is imaged by the hand imaging unit 240 (S106).

The information processing apparatus 200 recognizes the movement of the hand of the performer 20 by performing image recognition on the captured image of the hand imaging unit 240 (S107). Thereafter, the information processing apparatus 200 controls movement of the hand unit 120 on the basis of the recognized movement of the hand of the performer 20 (S108). As a result, the telepresence system can present the experiencing person 10 with an experience by a tactile sense reproducing the movement of the hand of the performer 20 in addition to an experience by conversation with the performer 20.

### 4. Detailed Configurations

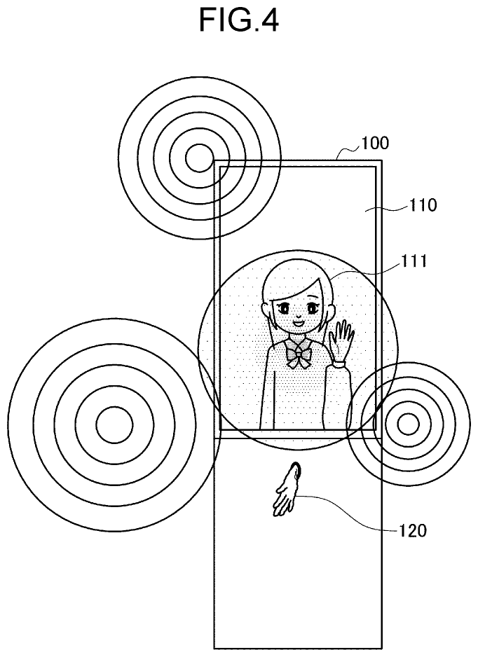

Next, each of detailed configurations of the telepresence system including the information processing apparatus 200 according to the present embodiment will be described with reference to FIGS. 4 to 20.

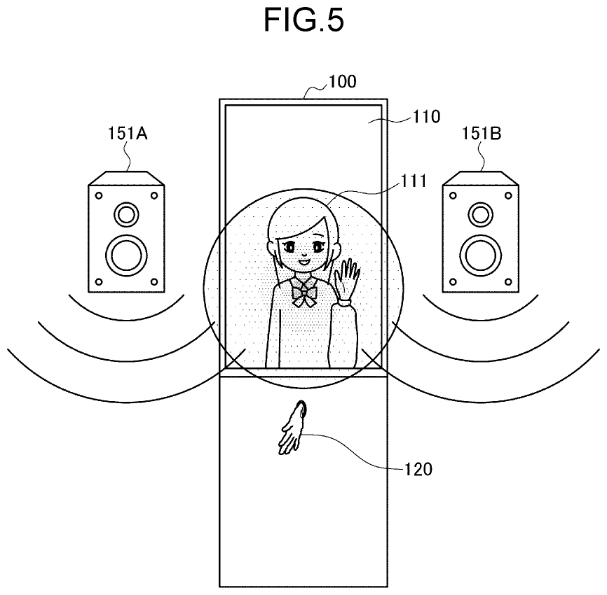

As one of the detailed configurations, the voice control unit 253 may control localization of voice output from the acoustic unit 150 of the experience providing apparatus 100. FIGS. 4 and 5 are explanatory views illustrating a configuration for controlling localization of the voice output from the acoustic unit 150 of the experience providing apparatus 100.

As illustrated in FIG. 4, the voice control unit 253 of the information processing apparatus 200 may control localization of the voice output from the acoustic unit 150 using a spatial sound technology by wavefront synthesis. According to this, the voice control unit 253 can localize the voice output from the acoustic unit 150 to the mouth of the performer 20 or the avatar in the communication image 111 displayed on the display unit 110. Therefore, the experience providing apparatus 100 can present a more realistic and natural voice of the performer 20 from the acoustic unit 150 to the experiencing person 10.

Alternatively, as illustrated in FIG. 5, the acoustic unit 150 may include speakers 151A and 151B arranged on the left and right of the display unit 110. In such a case, the voice control unit 253 of the information processing apparatus 200 can control localization of the voice output from the acoustic unit 150 using panning by the left and right speakers 151A and 151B. Therefore, similarly, the voice control unit 253 can localize the voice output from the acoustic unit 150 to the mouth of the performer 20 or the avatar in the communication image 111 displayed on the display unit 110.

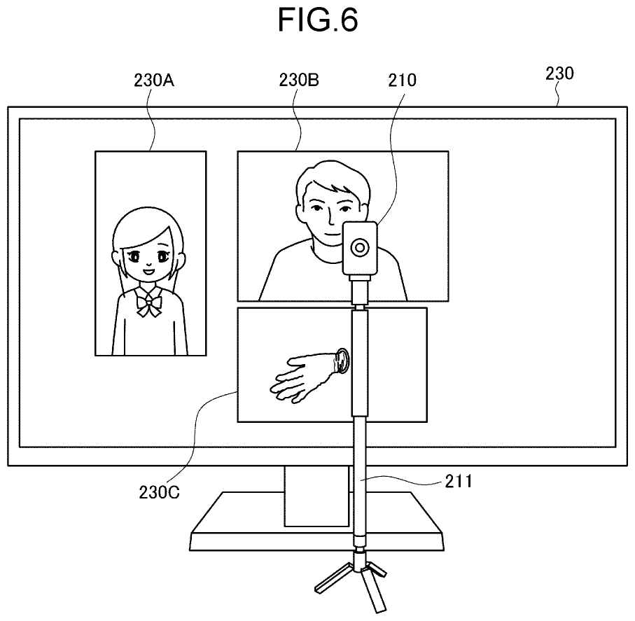

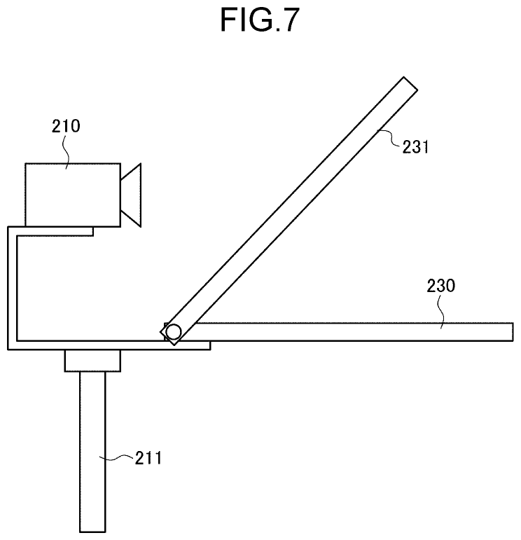

As one of the detailed configurations, the display unit 230 and the capture unit 210 of the information processing apparatus 200 may be arranged on the same axis. FIG. 6 is an explanatory view illustrating a positional relationship between the capture unit 210 and the display unit 230 of the information processing apparatus 200. FIG. 7 is an explanatory view illustrating an example in which the capture unit 210 and the display unit 230 are arranged on the same axis using a half mirror.

As illustrated in FIG. 6, the display unit 230 and the capture unit 210 of the information processing apparatus 200 may be arranged on the same axis. Specifically, the display unit 230 displays, for example, a display image 230A of the display unit 110, a captured image 230B of the experiencing person 10 captured by the bird's-eye view imaging unit 130, and a captured image 230C of contact between the hand of the experiencing person 10 and the hand unit 120 captured by the hand imaging unit 140. As an example, the capture unit 210 may be arranged in front of the display unit 230 on which these images are displayed by using a stand 211 such as a tripod. Furthermore, as another example, the capture unit 210 may be arranged in front of the display unit 230 by being suspended from the stand 211, a ceiling, or the like.

For example, in order to generate the more natural communication image 111, it is desirable that a line of sight of the performer 20 faces the capture unit 210. On the other hand, the performer 20 has a desire to confirm the captured images 230B and 230C that present expression or movement of the experiencing person 10 and the display image 230A visually recognized by the experiencing person 10. Therefore, by arranging the display unit 230 and the capture unit 210 on the same axis, the performer 20 can check the display image 230A and the captured images 230B and 230C, and at the same time, can direct the line of sight to the capture unit 210.

In addition, as illustrated in FIG. 7, the capture unit 210 and the display unit 230 may be arranged on the same axis using a half mirror 231. The half mirror 231 is an optical member that partially transmits light and partially reflects light.

Specifically, the display unit 230 may be provided to be connected to the stand 211 supporting the capture unit 210 with a display surface facing upward, and the half mirror 231 may be provided on the display unit 230 at an angle of 45° with respect to the display surface. The capture unit 210 may be provided on an opposite side of the display unit 230 across the half mirror 231.

According to this, an image displayed on the display surface of the display unit 230 can be reflected by the half mirror 231 and displayed on the performer 20 side. Furthermore, the capture unit 210 can capture an image on the performer 20 side that is transmitted through the half mirror 231. Therefore, by using the half mirror 231, the capture unit 210 and the display unit 230 can be arranged on the same axis without blocking a field of view of the performer 20 by the capture unit 210.

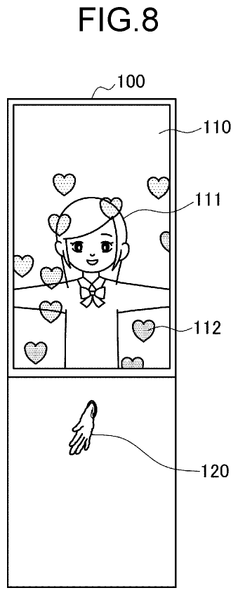

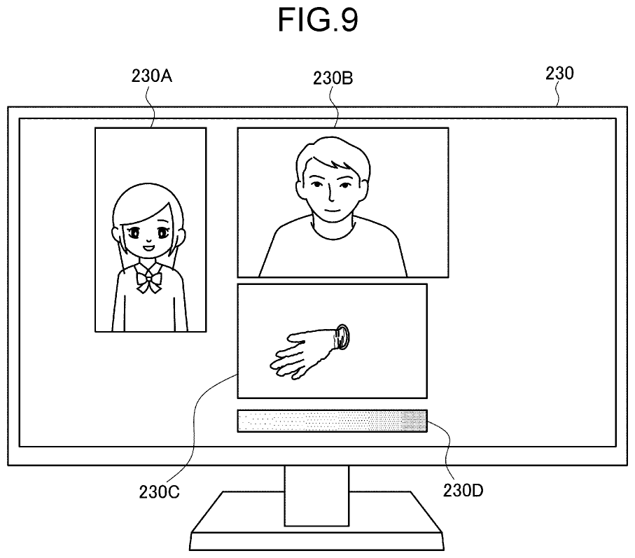

As one of the detailed configurations, pressure applied to the hand unit 120 from the experiencing person 10 may be visualized and presented to the experiencing person 10 or the performer 20. FIG. 8 is an explanatory view illustrating the communication image 111 to which an effect image corresponding to the pressure applied to the hand unit 120 is added. FIG. 9 is an explanatory view illustrating the display unit 230 in which information regarding the pressure applied to the hand unit 120 is presented.

As illustrated in FIG. 8, the image control unit 251 of the information processing apparatus 200 may superimpose an effect image 112 on the communication image 111 on the basis of the information regarding the pressure applied from the experiencing person 10 to the hand unit 120. Specifically, the image control unit 251 may superimpose the richer effect image 112 on the communication image 111 as the pressure applied from the experiencing person 10 to the hand unit 120 increases. For example, the image control unit 251 may superimpose more heart-shaped effect images 112 on the communication image 111 as the pressure applied from the experiencing person 10 to the hand unit 120 increases. Accordingly, since the image control unit 251 can visualize magnitude of the pressure applied from the experiencing person 10 to the hand unit 120, it is possible to provide the experiencing person 10 and the performer 20 with the pressure applied to the hand unit 120 as a conversation topic.

As illustrated in FIG. 9, the performer side control unit 254 may present the performer 20 with the magnitude of the pressure applied from the experiencing person 10 to the hand unit 120 by generating an indicator image 230D. In such a case, the display unit 230 displays, for example, the indicator image 230D indicating the magnitude of the pressure applied from the experiencing person 10 to the hand unit 120 in addition to the display image 230A of the display unit 110, the captured image 230B of the experiencing person 10 captured by the bird's-eye view imaging unit 130, and the captured image 230C of the contact between the hand of the experiencing person 10 and the hand unit 120 captured by the hand imaging unit 140. According to this, since the image control unit 251 can visualize the magnitude of the pressure applied from the experiencing person 10 to the hand unit 120, it is possible to provide the performer 20 with the pressure applied to the hand unit 120 as a topic of conversation. Therefore, the performer 20 can have conversation with the experiencing person 10 as if feeling pressure on the hand unit 120.

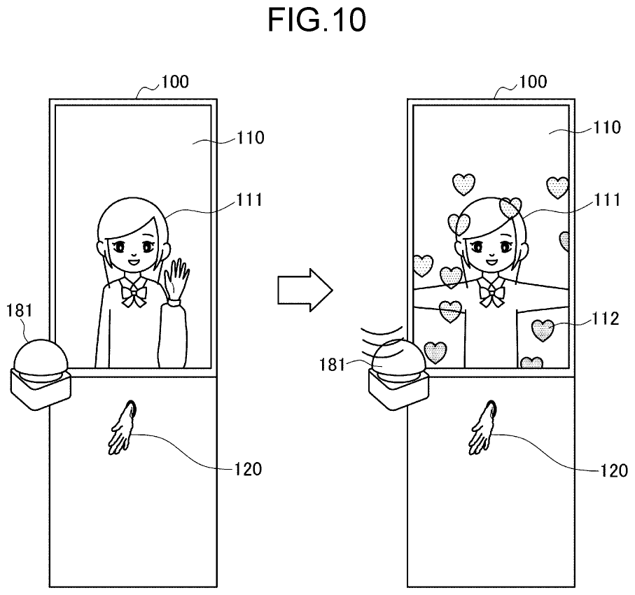

As one of the detailed configurations, the experience providing apparatus 100 may further include an input device 181. FIG. 10 is an explanatory view illustrating an aspect of the experience providing apparatus 100 in a case where input has been performed to the input device 181.

As illustrated in FIG. 10, the input device 181 is a button that generates a simple input such as pressing. For example, the image control unit 151 of the information processing apparatus 200 may superimpose the effect image 112 on the communication image 111 on the basis of the number of times the button of the input device 181 has been pressed. Specifically, the image control unit 251 may superimpose more heart-shaped effect images 112 on the communication image 111 as the number of times the button of the input device 181 has been pressed increases. According to this, the experiencing person 10 can make an action to the performer 20 by means other than conversation or handshake. Therefore, the experience providing apparatus 100 can provide the experiencing person 10 with a richer communication experience.

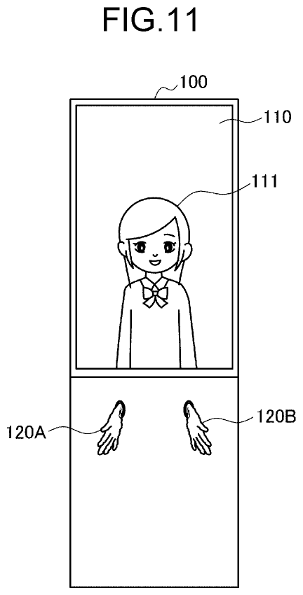

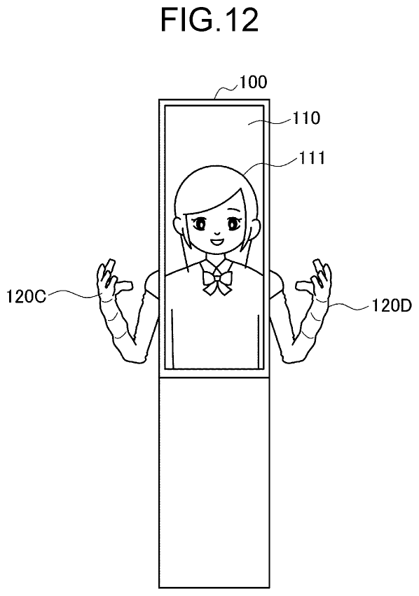

As one of the detailed configurations, the experience providing apparatus 100 may be provided with the plurality of hand units 120. FIG. 11 is an explanatory view illustrating the experience providing apparatus 100 provided with a first hand unit 120A and a second hand unit 120B corresponding to both hands. FIG. 12 is an explanatory view illustrating the experience providing apparatus 100 provided with a first hand unit 120C and a second hand unit 120D corresponding to both arms.

As illustrated in FIG. 11, the experience providing apparatus 100 may be provided with the first hand unit 120A corresponding to a right hand and the second hand unit 120B corresponding to a left hand. In such a case, the experience providing apparatus 100 can increase variations in experience with respect to a tactile sense. (For example, the hand of the experiencing person 10 is held by both the first hand unit 120A and the second hand unit 120B.) Therefore, the experience providing apparatus 100 can provide the experiencing person 10 with a more complicated experience.

Furthermore, as illustrated in FIG. 12, the experience providing apparatus 100 may be provided with the first hand unit 120C and the second hand unit 120D including a robot arm device having a structure imitating a human arm portion. Specifically, the experience providing apparatus 100 may be provided with the first hand unit 120C corresponding to a right arm and the second hand unit 120D corresponding to a left arm from both side surfaces of the display unit 110. The robot arm device included in the first hand unit 120C and the second hand unit 120D may be arranged at a position corresponding to the arm portion of a full-size image of the performer 20 or the avatar displayed on the display unit 110. In such a case, since the first hand unit 120C and the second hand unit 120D can perform more complicated movement, the experience providing apparatus 100 can further increase variations in experience with respect to a tactile sense. Therefore, the experience providing apparatus 100 can provide the experiencing person 10 with a more complicated experience.

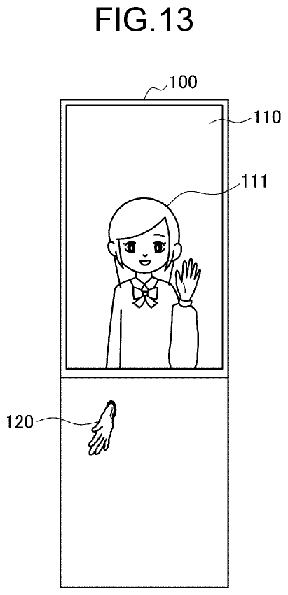

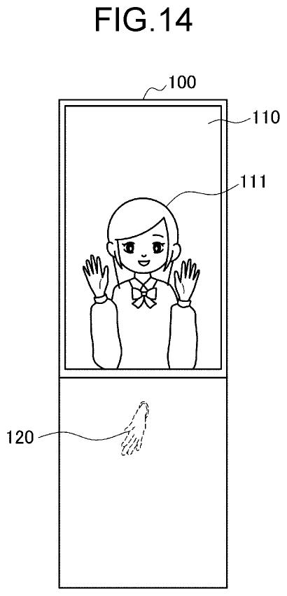

As one of the detailed configurations, the hand unit 120 may be controlled so as not to be presented to the experiencing person 10 at the same time as the hand of the performer 20 or the avatar included in the communication image 111. FIGS. 13 and 14 are explanatory views for explaining a method of avoiding duplexing of the hand unit 120 and the hand of the performer 20 or the avatar.

As illustrated in FIG. 13, in a case where the hand unit 120 corresponding to the right hand is presented to the experiencing person 10, as an example, the right hand of the avatar included in the communication image 111 may be controlled to deviate from an angle of view of the display unit 110. Furthermore, as another example, in a case where the hand unit 120 corresponding to the right hand is presented to the experiencing person 10, the right hand of the performer 20 may be prevented from being included in the communication image 111 by fixing the right hand of the performer 20 at a position deviated from the angle of view of the display unit 110. For example, in a case where it is recognized that the right hand of the performer 20 is placed at a position deviated from the angle of view imaged by the capture unit 210, the information processing apparatus 200 may control the hand unit 120 such that the hand unit 120 corresponding to the right hand is presented to the experiencing person 10.

Furthermore, as illustrated in FIG. 14, in a case where the information processing apparatus 200 recognizes that the hand of the performer 20 or the avatar is included in the communication image 111, the information processing apparatus 200 may control the hand unit 120 such that the corresponding hand unit 120 is not presented to the experiencing person 10. Specifically, the information processing apparatus 200 may perform control to hide the hand unit 120 corresponding to the hand recognized to be included in the communication image 111 from the experiencing person 10.

Accordingly, the information processing apparatus 200 can avoid duplexing in which the hand unit 120 and the hand of the performer 20 or the avatar simultaneously exist in front of the experiencing person 10. Therefore, the information processing apparatus 200 can further enhance recognition of the experiencing person 10 that the hand unit 120 corresponds to the hand of the performer 20 or the avatar, and thus can further enhance a realistic feeling of the hand unit 120.

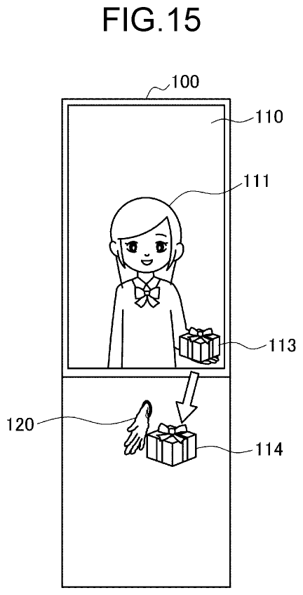

As one of the detailed configurations, the experience providing apparatus 100 may provide the experiencing person 10 with an experience in which an object 113 displayed on the display unit 110 is delivered to the experiencing person 10 as a real object 114. FIG. 15 is an explanatory view for explaining an experience in which the object 113 displayed on the display unit 110 is delivered to the experiencing person 10 as the real object 114.

As illustrated in FIG. 15, for example, the experience providing apparatus 100 may be provided so as to be able to deliver the real object 114 corresponding to the object 113 displayed on the display unit 110 to the experiencing person 10. Specifically, the information processing apparatus 200 first generates an image of the object 113 corresponding to the real object 114 in the image control unit 251, and displays the object 113 on the display unit 110. Thereafter, the information processing apparatus 200 may remove the object 113 displayed on the display unit 110 from the angle of view and at the same time deliver the real object 114 stored in the experience providing apparatus 100 to the experiencing person 10. According to this, the experiencing person 10 can obtain recognition as if the real object 114 has been delivered across a space from a space displayed on the display unit 110. Therefore, the experience providing apparatus 100 and the information processing apparatus 200 can provide the experiencing person 10 with a more complicated and richer experience.

As one of the detailed configurations, the hand unit 120 is not fixed and can move forward, backward, leftward, and rightward, and the forward, backward, leftward, and rightward movement applied to the hand unit 120 from the experiencing person 10 may be fed back to the performer 20 or the communication image 111. FIG. 16 is an explanatory view illustrating a robot hand structure 121 capable of following forward, backward, leftward, and rightward movement from the experiencing person 10.

As illustrated in FIG. 16, the robot hand structure 121 includes a plurality of links 121C and 121B and an end portion 121A connected to each other by joints. The joints connecting the plurality of links 121C and 121B and the end portion 121A to each other are controlled by a weak servo so that the joints can be rotated by force of the experiencing person 10. Since the hand unit 120 has the robot hand structure 121, the hand unit can be moved forward, backward, rightward, and leftward by the experiencing person 10, and can detect forward, backward, leftward, and rightward movement applied to the experiencing person 10.

In a case where motion that moves the hand unit 120 back and forth and left and right is applied to the hand unit 120 from the experiencing person 10, the hand unit 120 may detect the motion applied from the experiencing person 10. As an example, the motion detected by the hand unit 120 may be presented to the performer 20 by being imaged by the performer side control unit 254 of the information processing apparatus 200. As another example, the motion detected by the hand unit 120 may be used by the image control unit 251 of the information processing apparatus 200 to control the avatar image included in the communication image 111.

According to this, in a case where the experiencing person 10 moves the hand unit 120 back and forth and left and right, the information processing apparatus 200 can present the movement applied to the hand unit 120 by the experiencing person 10 to the performer 20 or reflect the movement in that of the avatar. Therefore, the information processing apparatus 200 can further enhance recognition of the experiencing person 10 that the hand unit 120 corresponds to the hand of the performer 20 or the avatar, and thus can further enhance quality of experience by the hand unit 120.

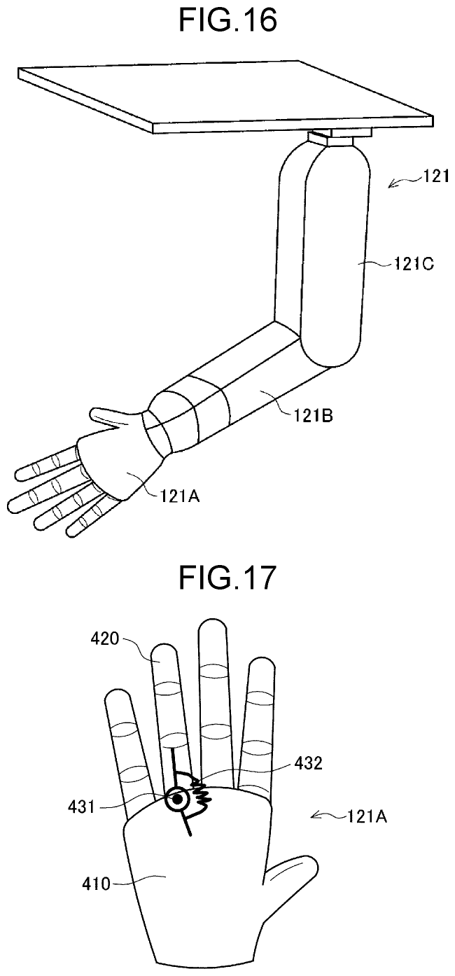

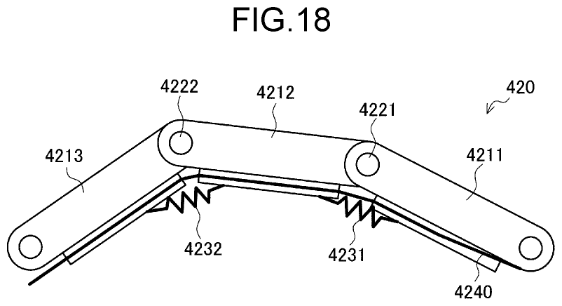

As one of the detailed configurations, the end portion 121A included in the hand unit 120 may be provided so as to move close to a human hand. FIG. 17 is an explanatory view for explaining a configuration of the end portion 121A that enables motion close to a human hand. FIG. 18 is an explanatory view for explaining a configuration of a finger portion 420 that enables motion close to a human finger.

As illustrated in FIG. 17, the end portion 121A imitating the human hand includes a palm portion 410 and a plurality of finger portions 420 extending from the palm portion 410. Each of the plurality of finger portions 420 may be connected to the palm portion 410 by a joint 431 rotatable on an axis perpendicular to a plane of the palm portion 410 and an elastic member 432 that contracts between the palm portion 410 and the finger portion 420 connected by the joint 431.

Here, in the human hand, when shifting from an open state to a closed state, each of the fingers naturally shifts from a state of radially spreading from the palm to a state of being closed parallel to the palm. Therefore, when shifting from the open state to the closed state, the end portion 121A can imitate the motion of the human hand by rotating an extending direction of the finger portion 420 in an in-plane direction of the palm portion 410 using the joint 431 and the elastic member 432. Accordingly, the end portion 121A can move closer to the human hand.

As illustrated in FIG. 18, the finger portion 420 imitating the human finger includes a plurality of links 4211, 4212, 4213, a plurality of joints 4221, 4222, a drive wire 4240, and elastic members 4231, 4232.

The plurality of links 4211, 4212, and 4213 is rotatably provided in the plurality of joints 4221 and 4222. For example, the finger portion 420 is bent in conjunction with each other by pulling the drive wire 4240 provided along the plurality of links 4211, 4212, and 4213. The elastic member 4231 is provided between the plurality of links 4211 and 4212 in parallel with the joint 4221, and applies a repulsive force between the plurality of links 4211 and 4212. The elastic member 4232 is provided between the plurality of links 4212 and 4213 in parallel with the joint 4222, and applies a repulsive force between the plurality of links 4212 and 4213.

Here, when a human finger bends, one joint does not bend first, but joints gradually interlock and bend. Therefore, the finger portion 420 can be bent in conjunction with the plurality of links 4211, 4212, and 4213 by dispersing tension by the drive wire 4240 to the plurality of links 4211, 4212, and 4213 by the elastic members 4231 and 4232. Consequently, the finger portion 420 can imitate the motion of the human finger, and can move closer to the motion of the human finger.

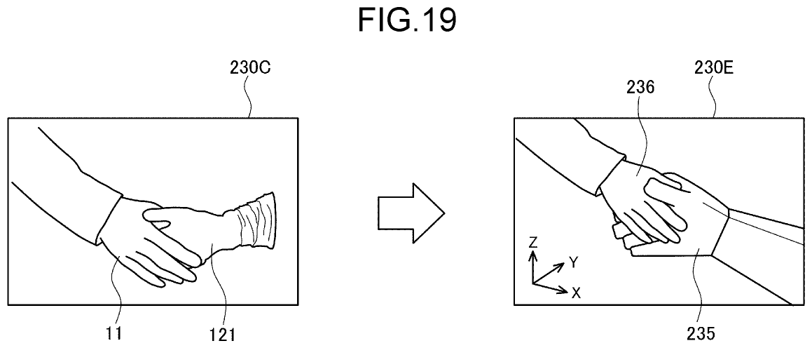

As one of the detailed configurations, the hand unit 120 is not fixed and can move back and forth and right and left, and the performer 20 may move the hand unit 120 back and forth and right and left to perform contact such as shaking hands with the hand of the experiencing person 10. FIG. 19 is an explanatory view illustrating an example of an image for presenting a positional relationship between a hand 11 of the experiencing person 10 and the hand unit 120 to the performer 20.

As illustrated in FIG. 19, the performer side control unit 254 may generate an image 230E indicating a three-dimensional positional relationship between the hand 11 of the experiencing person 10 and the hand unit 120 instead of or in addition to the captured image 230C of the contact between the hand 11 of the experiencing person 10 and the hand unit 120 captured by the hand imaging unit 140.

Specifically, the performer side control unit 254 first estimates the three-dimensional positional relationship between the hand 11 of the experiencing person 10 and the hand unit 120 on the basis of the captured image 230C of the contact between the hand 11 of the experiencing person 10 and the hand unit 120. Next, the performer side control unit 254 generates the image 230E of a three-dimensional virtual space including a model 236 of the hand 11 of the experiencing person 10 and a model 235 of the hand unit 120 on the basis of the estimated three-dimensional positional relationship between the hand 11 of the experiencing person 10 and the hand unit 120. The performer side control unit 254 can present the performer 20 with the three-dimensional positional relationship between the hand 11 of the experiencing person 10 and the hand unit 120 by displaying the image 230E of the three-dimensional virtual space on the display unit 230.

According to this, since the performer 20 can grasp the three-dimensional positional relationship between the hand 11 of the experiencing person 10 and the hand unit 120, the hand unit 120 can be moved back and forth and left and right to perform contact such as shaking hands with the hand 11 of the experiencing person 10 from the hand unit 120. Therefore, the information processing apparatus 200 can cause the experiencing person 10 to more smoothly experience contact such as a handshake.

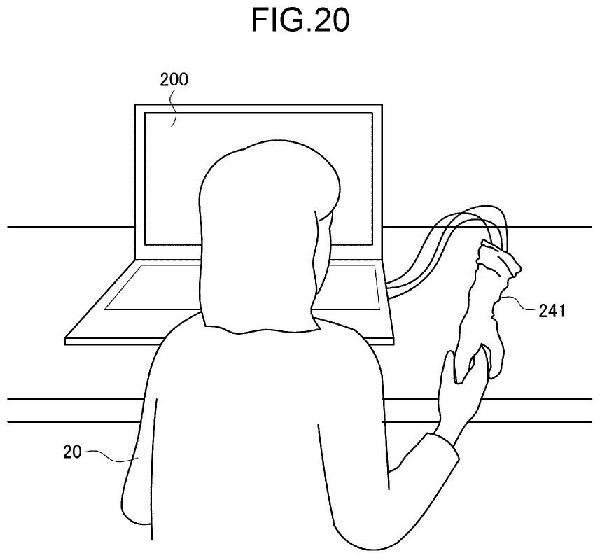

As one of the detailed configurations, the information processing apparatus 200 may further include a performer side hand unit 241. FIG. 20 is an explanatory view for explaining a function of the performer side hand unit 241.

As illustrated in FIG. 20, similarly to the hand unit 120, the performer side hand unit 241 includes a robot hand device having a structure that mimics a human hand, and presents a form such as pressure, gripping force, or a handshake applied to the hand unit 120 by the experiencing person 10 to the performer 20. For example, the performer side hand unit 241 can reproduce movement of the hand of the experiencing person 10 estimated by performing image recognition on the captured image of the hand of the experiencing person 10 captured by the hand imaging unit 140. Accordingly, the performer side hand unit 241 can present a tactile sense as if the performer 20 is actually in contact with the experiencing person 10 by shaking hands or the like.

Furthermore, the performer side hand unit 241 may be provided with a pressure sensor or a force sensor that detects pressure or a force sense applied from the performer 20 to the performer side hand unit 241. Accordingly, the information processing apparatus 200 can cause the hand unit 120 to reproduce the pressure or the force sense applied to the performer side hand unit 241 by the performer 20. Therefore, the information processing apparatus 200 can provide the experiencing person 10 with a more realistic tactile sense from the performer 20 via the hand unit 120.

### 5. Hardware Configuration Example

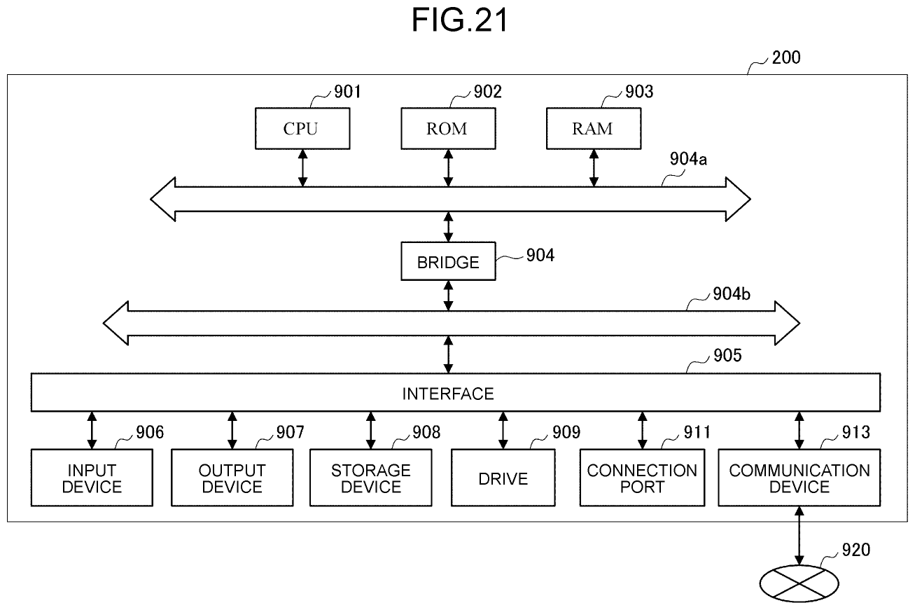

Furthermore, a hardware configuration of the information processing apparatus 200 according to the present embodiment will be described with reference to FIG. 21. FIG. 21 is a block diagram illustrating a hardware configuration example of the information processing apparatus 200 according to the present embodiment.

A function of the information processing apparatus 200 according to the present embodiment can be realized by cooperation of software and hardware described below. A function of the control unit 250 may be executed by a CPU 901, for example. A function of the communication unit 270 may be executed by, for example, a connection port 923 or a communication device 925.

As illustrated in FIG. 21, the information processing apparatus 200 includes the central processing unit (CPU) 901, a read only memory (ROM) 903, and a random access memory (RAM) 905.

Furthermore, the information processing apparatus 200 may further include a host bus 907, a bridge 909, an external bus 911, an interface 913, an input device 915, an output device 917, a storage device 919, a drive 921, the connection port 923, or the communication device 925. Furthermore, the information processing apparatus 200 may include an imaging device 933 or a sensor 935 as necessary. The information processing apparatus 200 may include a processing circuit such as a digital signal processor (DSP) or an application specific integrated circuit (ASIC) instead of the CPU 901 or together with the CPU 901.

The CPU 901 functions as an arithmetic processing device or a control device, and controls an operation in the information processing apparatus 200 according to various programs recorded in the ROM 903, the RAM 905, the storage device 919, or a removable recording medium 927. The ROM 903 stores programs, operation parameters, and the like used by the CPU 901. The RAM 905 temporarily stores programs used in execution of the CPU 901, parameters used in the execution, and the like.

The CPU 901, the ROM 903, and the RAM 905 are mutually connected by the host bus 907 capable of high-speed data transmission. The host bus 907 is connected to the external bus 911 such as a peripheral component interconnect/interface (PCI) bus via the bridge 909, and the external bus 911 is connected to various components via the interface 913.

The input device 915 is, for example, a device that receives an input from a user, such as a mouse, a keyboard, a touch panel, a button, a switch, or a lever. Note that the input device 915 may be a microphone or the like that detects user's voice. The input device 915 may be, for example, a remote control device using infrared rays or other radio waves, or may be an external connection device 929 corresponding to the operation of the information processing apparatus 200.

The input device 915 further includes an input control circuit that outputs an input signal generated on the basis of information input by a user to the CPU 901. The user can input various kinds of data or instruct a processing operation to the information processing apparatus 200 by operating the input device 915.

The output device 917 is a device capable of visually or aurally presenting information acquired or generated by the information processing apparatus 200 to a user. The output device 917 may be, for example, a display device such as a liquid crystal display (LCD), a plasma display panel (PDP), an organic light emitting diode (OLED) display, a hologram, or a projector, a sound output device such as a speaker or a headphone, or a printing device such as a printer device. The output device 917 can output information obtained by processing of the information processing apparatus 200 as a video such as a text or an image, or a sound such as voice or audio.

The storage device 919 is a data storage device configured as an example of a storage unit of the information processing apparatus 200. The storage device 919 may include, for example, a magnetic storage device such as a hard disk drive (HDD), a semiconductor storage device, an optical storage device, a magneto-optical storage device, or the like. The storage device 919 can store programs executed by the CPU 901, various data, various data acquired from the outside, or the like.

The drive 921 is a reading or writing device of the removable recording medium 927 such as a magnetic disk, an optical disk, a magneto-optical disk, or a semiconductor memory, and is built in or externally attached to the information processing apparatus 200. For example, the drive 921 can read information recorded in the attached removable recording medium 927 and output the information to the RAM 905. Furthermore, the drive 921 can write a record in the attached removable recording medium 927.

The connection port 923 is a port for directly connecting the external connection device 929 to the information processing apparatus 200. The connection port 923 may be, for example, a universal serial bus (USB) port, an IEEE 1394 port, a small computer system interface (SCSI) port, or the like. Furthermore, the connection port 923 may be an RS-232C port, an optical audio terminal, a high-definition multimedia interface (HDMI) (registered trademark) port, or the like. By being connected with the external connection device 929, the connection port 923 can transmit and receive various data between the information processing apparatus 200 and the external connection device 929.

The communication device 925 is, for example, a communication interface including a communication device or the like for connecting to a communication network 931. The communication device 925 may be, for example, a communication card for wired or wireless local area network (LAN), Wi-Fi (registered trademark), Bluetooth (registered trademark), or wireless USB (WUSB). Furthermore, the communication device 925 may be a router for optical communication, a router for asymmetric digital subscriber line (ADSL), a modem for various types of communication, or the like.

The communication device 925 can transmit and receive signals and the like using a predetermined protocol such as TCP/IP to and from the Internet or another communication device, for example. Furthermore, the communication network 931 connected to the communication device 925 is a network connected in a wired or wireless manner, and may be, for example, an Internet communication network, a home LAN, an infrared communication network, a radio wave communication network, a satellite communication network, or the like.

Note that it is also possible to create a program for causing hardware such as the CPU 901, the ROM 903, and the RAM 905 built in a computer to exhibit functions equivalent to those of the information processing apparatus 200 described above. In addition, a computer-readable recording medium in which the program is recorded can also be provided.

Although the preferred embodiment of the present disclosure has been described in detail with reference to the accompanying drawings, the technical scope of the present disclosure is not limited to such examples. It is obvious that a person having ordinary knowledge in the technical field of the present disclosure can conceive various changes or modifications within the scope of the technical idea described in the claims, and it is naturally understood that these also belong to the technical scope of the present disclosure.

Furthermore, the effects described in the present specification are merely illustrative or exemplary, and are not restrictive. That is, the technology according to the present disclosure can exhibit other effects obvious to those skilled in the art from the description of the present specification together with or instead of the above effects.

Note that the following configurations also belong to the technical scope of the present disclosure.

(1)

An information processing apparatus comprising:
an image control unit that controls a communication image including an image of a performer or an avatar and displayed on a display unit installed in a separated space and having a vertical direction as a longitudinal direction; and
a hand control unit that controls movement of a robot hand that provides an experience by a tactile sense to an experiencing person who has visually recognized the image.
   (2)

The information processing apparatus according to (1), wherein the communication image includes an image of the avatar tracing expression or gesture of the performer or a captured image of the performer.

(3)

The information processing apparatus according to (2), wherein a size of the display unit is a size in which a full-size upper body of the performer is reflected.

(4)

The information processing apparatus according to any one of (1) to (3), further comprising a voice control unit that controls voice output of the performer to the experiencing person.

(5)

The information processing apparatus according to (4), wherein the voice control unit controls the voice output of the performer so that voice of the performer is localized at a mouth of the performer or the avatar included in the communication image and is heard by the experiencing person.

(6)

The information processing apparatus according to any one of (1) to (5), wherein the image control unit controls the communication image on a basis of information regarding pressure by the tactile sense from the experiencing person to the robot hand.

(7)

The information processing apparatus according to any one of (1) to (6), further comprising a performer side control unit that controls presentation of a captured image and voice of the experiencing person to the performer.

(8)

The information processing apparatus according to (7), wherein the performer side control unit further presents the performer with information regarding pressure by the tactile sense from the experiencing person to the robot hand.

(9)

The information processing apparatus according to (8), wherein the performer side control unit presents the performer with the information regarding the pressure by the tactile sense via a robot hand provided on a side of the performer.

(10)

The information processing apparatus according to any one of (7) to (9), wherein the performer side control unit further presents information regarding the movement of the robot hand to the performer.

(11)

The information processing apparatus according to (10), wherein the performer side control unit further presents the performer with information regarding a positional relationship between the robot hand and a hand of the experiencing person.

(12)

The information processing apparatus according to any one of (1) to (11), wherein the robot hand has a shape imitating a human hand.

(13)

The information processing apparatus according to (12), wherein the robot hand includes a first robot hand imitating a right hand and a second robot hand imitating a left hand.

(14)

The information processing apparatus according to (12), wherein the robot hand has a shape imitating an arm and a hand beyond a shoulder or an elbow of a human.

(15)

The information processing apparatus according to any one of (12) to (14), wherein the robot hand is provided at a position corresponding to an arm of the performer or the avatar included in the communication image.

(16)

The information processing apparatus according to (15),
wherein the robot hand is provided to be operable following contact by the experiencing person, and
the image control unit controls the image of the performer or the avatar included in the communication image in accordance with the movement of the robot hand.
   (17)

The information processing apparatus according to (15) or (16), wherein the hand control unit controls the robot hand such that the robot hand appears in front of the experiencing person in a case where the arm of the performer is deviated from an angle of view of the communication image.

(18)

The information processing apparatus according to any one of (15) to (17), wherein in a case where the robot hand appears in front of the experiencing person, the image control unit controls the communication image such that the arm of the avatar corresponding to the robot hand deviates from an angle of view of the communication image.

(19)

An information processing method comprising:
by means of a computer,
controlling a communication image displayed on a display unit installed at a separated place and having a vertical direction as a longitudinal direction; and
controlling movement of a robot hand that provides an experience by a tactile sense to an experiencing person who has visually recognized the image.

### REFERENCE SIGNS LIST

1 FIRST SPACE
2 SECOND SPACE
10 EXPERIENCING PERSON
20 PERFORMER
100 EXPERIENCE PROVIDING APPARATUS
110 DISPLAY UNIT
111 COMMUNICATION IMAGE
120 HAND UNIT
130 BIRD'S-EYE VIEW IMAGING UNIT
140 HAND IMAGING UNIT
150 ACOUSTIC UNIT
160 SENSOR UNIT
170 COMMUNICATION UNIT
200 INFORMATION PROCESSING APPARATUS
210 CAPTURE UNIT
220 ACOUSTIC UNIT
230 DISPLAY UNIT
240 HAND IMAGING UNIT
250 CONTROL UNIT
251 IMAGE CONTROL UNIT
252 HAND CONTROL UNIT
253 VOICE CONTROL UNIT
254 PERFORMER SIDE CONTROL UNIT
255 HAND RECOGNITION UNIT
270 COMMUNICATION UNIT
300 COMMUNICATION NETWORK

1. An information processing apparatus comprising:
an image control unit that controls a communication image including an image of a performer or an avatar and displayed on a display unit installed in a separated space and having a vertical direction as a longitudinal direction; and
a hand control unit that controls movement of a robot hand that provides an experience by a tactile sense to an experiencing person who has visually recognized the image.

2. The information processing apparatus according to claim 1, wherein the communication image includes an image of the avatar tracing expression or gesture of the performer or a captured image of the performer.

3. The information processing apparatus according to claim 2, wherein a size of the display unit is a size in which a full-size upper body of the performer is reflected.

4. The information processing apparatus according to claim 1, further comprising a voice control unit that controls voice output of the performer to the experiencing person.

5. The information processing apparatus according to claim 4, wherein the voice control unit controls the voice output of the performer so that voice of the performer is localized at a mouth of the performer or the avatar included in the communication image and is heard by the experiencing person.

6. The information processing apparatus according to claim 1, wherein the image control unit controls the communication image on a basis of information regarding pressure by the tactile sense from the experiencing person to the robot hand.

7. The information processing apparatus according to claim 1, further comprising a performer side control unit that controls presentation of a captured image and voice of the experiencing person to the performer.

8. The information processing apparatus according to claim 7, wherein the performer side control unit further presents the performer with information regarding pressure by the tactile sense from the experiencing person to the robot hand.

9. The information processing apparatus according to claim 8, wherein the performer side control unit presents the performer with the information regarding the pressure by the tactile sense via a robot hand provided on a side of the performer.

10. The information processing apparatus according to claim 7, wherein the performer side control unit further presents information regarding the movement of the robot hand to the performer.

11. The information processing apparatus according to claim 10, wherein the performer side control unit further presents the performer with information regarding a positional relationship between the robot hand and a hand of the experiencing person.

12. The information processing apparatus according to claim 1, wherein the robot hand has a shape imitating a human hand.

13. The information processing apparatus according to claim 12, wherein the robot hand includes a first robot hand imitating a right hand and a second robot hand imitating a left hand.

14. The information processing apparatus according to claim 12, wherein the robot hand has a shape imitating an arm and a hand beyond a shoulder or an elbow of a human.

15. The information processing apparatus according to claim 12, wherein the robot hand is provided at a position corresponding to an arm of the performer or the avatar included in the communication image.

16. The information processing apparatus according to claim 15,
wherein the robot hand is provided to be operable following contact by the experiencing person, and
the image control unit controls the image of the performer or the avatar included in the communication image in accordance with the movement of the robot hand.

17. The information processing apparatus according to claim 15, wherein the hand control unit controls the robot hand such that the robot hand appears in front of the experiencing person in a case where the arm of the performer is deviated from an angle of view of the communication image.

18. The information processing apparatus according to claim 15, wherein in a case where the robot hand appears in front of the experiencing person, the image control unit controls the communication image such that the arm of the avatar corresponding to the robot hand deviates from an angle of view of the communication image.

19. An information processing method comprising:
by means of a computer,
controlling a communication image displayed on a display unit installed at a separated place and having a vertical direction as a longitudinal direction; and
controlling movement of a robot hand that provides an experience by a tactile sense to an experiencing person who has visually recognized the image.
